(19) United States
(12) Patent Application Publication
(10) Pub. No.: US 2012/0098162 A1
(43) Pub. Date: Apr. 26, 2012

(54) RAPID HOT PRESSING USING AN INDUCTIVE HEATER

(75) Inventors: G. Jeffrey Snyder, Pasadena, CA (US); Aaron LaLonde, Pasadena, CA (US); Teruyuki Ikeda, Pasadena, CA (US)

(73) Assignee: California Institute of Technology, Pasadena, CA (US)

(21) Appl. No.: 13/282,178

(22) Filed: Oct. 26, 2011

Related U.S. Application Data
(60) Provisional application No. 61/406,638, filed on Oct. 26, 2010.

(51) Int. Cl. B29C 35/12; B28B 7/42

(52) U.S. Cl. 264/403; 425/234

(57) ABSTRACT

A rapid hot press (RHP) method and system in which heat is supplied by RF induction to rapidly consolidate a material is described. Use of RF induction heating enables rapid heating and consolidation of powdered materials over a wide temperature range. Details of an exemplary system, instrumentation and performance using a thermoelectric material as an example are disclosed. The novel technique may be applied to any known sinterable materials. Notable applicable materials include thermoelectric materials, such as PbTe. An exemplary thermoelectric PbTe material may be pressed at an optimized temperature and time according to the technique to be consolidated under typical parameters and yield suitable properties of Seebeck coefficient, electrical resistivity, and thermal diffusivity.

### CROSS-REFERENCE TO RELATED APPLICATIONS

This application claims the benefit under 35 U.S.C. §119(e) of the following U.S. provisional patent application, which is incorporated by reference herein:

U.S. Provisional Patent Application No. 61/406,638, filed Oct. 26, 2010, and entitled “Rapid Hot Press using RF Heated Graphite Die as Susceptor”, by Snyder et al. (Attorney Docket CIT-5722-P).

### BACKGROUND OF THE INVENTION

1. Field of the Invention

This invention relates to hot pressing. Particularly, this invention relates to hot pressing in order to sinter thermoelectric materials.

2. Description of the Related Art

Processing of many materials ultimately requires consolidation of powdered material into dense ingots or discs for subsequent steps in device fabrication. Thermoelectric materials are one example. Typical consolidation techniques applied to thermoelectric materials include hot pressing using resistance heaters and spark plasma sintering (SPS). In addition, inductive hot pressing has also been employed in some cases. While each method is capable of consolidating material, there are disadvantages associated with each making an alternative approach to consolidation desirable.

The use of known Spark Plasma Sintering (SPS) hot pressing has grown rapidly in recent years and includes many variants. A significant, poorly understood characteristic of the SPS method is the electrically driven transport of ions within the material during consolidation leading to significant chemistry variation in the consolidated material. While it is not clear that sparking or plasma is involved, SPS systems have become widely used for the consolidation of fine grained and nanomaterials because of its speed compared to conventional (pressureless) sintering or even conventional hot pressing. Such rapid pressing is particularly important when consolidating nanomaterials in order to limit grain growth. Much of the advantage of SPS may be due to the rapid heating rate during uniaxial pressing, a parameter that could be achieved by other means that avoid the high currents and other effects of SPS.

Although SPS systems will provide rapid consolidation in nanomaterials, conventional SPS systems are relatively expensive. In a typical SPS system, the pressing rods and die body are resistively heated as well. In addition, such systems have other drawbacks. Customization is limited with SPS systems because changing die sizes in an SPS system will alter the heating characteristic of the die as it is a function of the die resistance and the current flow through the die. In an typical SPS system, the electrodes are large precision machined pieces and considerable cost and effort is made to minimize contact resistances between connections. It has also been shown in SPS systems that the temperature distribution within the pressing die is dependent on the material being consolidated and the electrode design and configuration. Scaling up of SPS systems is relatively difficult because of the size and cost of the necessary power supply.

Although resistance heater hot pressing does not suffer from the chemistry variation of SPS, the heating rate of a resistance heater hot pressing system is relatively slow as the heat is radiated throughout the entire chamber. From a design flexibility standpoint the ability to use different size pressing dies without making other changes to the system adds versatility to the system. Additionally, the heating elements and related connections in a resistance heater hot pressing system are expensive custom machined pieces that are very fragile.

In view of the foregoing, there is a need in the art for improved apparatuses and methods for consolidating powdered materials. There is particularly a need for such apparatuses and methods for semiconductor materials, such as SiGe and thermoelectric materials, including PbTe. Further, there is a need for such systems and methods to be efficient, fast and affordable. There is also a need for such systems and methods to be customizable and scalable. These and other needs are met by embodiments of the present invention as detailed hereafter.

### SUMMARY OF THE INVENTION

Rapid hot press (RHP) systems and methods in which heat is supplied by RF induction to rapidly consolidate a material is described. Use of RF induction heating enables rapid heating and consolidation of powdered materials over a wide temperature range. Details of an exemplary system, instrumentation and performance using a thermoelectric material as an example are disclosed. The novel technique may be applied to any known sinterable materials including semiconductor materials such as SiGe. Notable applicable materials include thermoelectric materials, such as PbTe. An exemplary thermoelectric PbTe material may be pressed at an optimized temperature and time according to the technique to be consolidated under typical parameters and yield suitable properties of Seebeck coefficient, electrical resistivity, and thermal diffusivity.

A typical embodiment of the invention comprises an apparatus for rapid hot pressing including a graphite die having a central bore therethrough, a stack disposed through the central bore comprising, a first graphite rod, a powdered material disposed above the first graphite rod, and a second graphite rod disposed above the powdered material such that the second graphite rod extends beyond a top surface of the graphite die, a ram press disposed to apply pressure to the stack, an inductive coil disposed around the graphite die, an insulator disposed between the graphite die and the inductive coil to prevent shorting of the inductive coil and align the inductive coil with the graphite die, and an RF electrical power supply coupled to the inductive coil for powering the conductive coil and heating the graphite die. The powdered material is heated by the graphite die and the graphite die and the inductive coil are disposed to remain fixed as the ram press applies pressure to the stack in order to consolidate the powdered material.

In further embodiments, one or more thermocouples may be disposed within the graphite die in order to monitor temperature of the graphite die. The stack may further comprise one or more graphite spacers in order to obtain vertical alignment of the powdered material within the graphite die and the inductive coil. In addition, a ceramic spacer may be disposed to support both the graphite die and the first graphite rod. Typically, the graphite die and the first and the second graphite rods may comprise high strength, high thermal conductivity graphite.

In some embodiments, the powdered material may comprise a semiconductor material, e.g. SiGe or other known semiconductor materials suitable for hot pressing. In some notable embodiments, the semiconductor material may comprise a thermoelectric material, e.g. PbTe.

A typical method embodiment of the invention comprises a method of rapid hot pressing including the steps of disposing a stack through a central bore of a graphite die, the stack comprising a first graphite rod, a powdered material disposed above the first graphite rod, and a second graphite rod disposed above the powdered material such that the second graphite rod extends beyond a top surface of the graphite die, disposing an insulator between the graphite die and the inductive coil to prevent shorting of the inductive coil and align the inductive coil with the graphite die, heating the graphite die by applying electrical power to an inductive coil disposed around the graphite die with an RF electrical power supply coupled to the inductive coil for powering the conductive coil, and applying pressure to the stack with a ram press. The powdered material is heated by the graphite die and the graphite die and the inductive coil are disposed to remain fixed as the ram press applies pressure to the stack in order to consolidate the powdered material. This method embodiment of the invention may be further modified consistent with the apparatus embodiments described herein.

Another typical embodiment of the invention may comprise an apparatus for hot pressing including a graphite die means for supporting and heating a powdered material having a central bore therethrough, a stack disposed through the central bore comprising, a first graphite rod, the powdered material disposed above the first graphite rod, and a second graphite rod disposed above the powdered material such that the second graphite rod extends beyond a top surface of the graphite die means, a ram press means for applying pressure to the stack, an inductive coil means for heating the graphite die means disposed around the graphite die means, an insulator means for insulating and aligning the inductive coil means and the graphite die means, the insulator means disposed between the graphite die means and the inductive coil means, and an RF electrical power supply means for powering the conductive coil means and heating the graphite die means coupled to the inductive coil means. The powdered material is heated by the graphite die means and the graphite die means and the inductive coil means are disposed to remain fixed as the ram press means applies pressure to the stack in order to consolidate the powdered material. This embodiment of the invention may be further modified consistent with the apparatus or method embodiments described herein.

### BRIEF DESCRIPTION OF THE DRAWINGS

Referring now to the drawings in which like reference numbers represent corresponding parts throughout:

FIG. 1 is a schematic diagram of an exemplary system for rapid hot pressing according to an embodiment of the invention;

FIG. 2 is an example plot of temperature versus ram displacement for consolidation of a sample at 623 K for 10 minutes;

FIGS. 3A to 3C show heating and cooling data plots of the measured Seebeck coefficient, resistivity, and thermal diffusivity, respectively, for two example PbTe samples under vacuum; and

FIG. 4 is a flowchart of an exemplary method of rapid hot pressing according to an embodiment of the invention.

### DETAILED DESCRIPTION OF THE PREFERRED EMBODIMENT

### 1. Overview

There are many disadvantages of existing resistance heater, SPS, and inductive hot pressing systems that are not present in the innovative inductive rapid hot pressing (RHP) technique of the present invention, making it an attractive alternative for producing consolidated thermoelectric materials. RHP also provides an improvement over both conventional SPS and resistance heater hot pressing. RHP costs may be somewhat lower than resistance heater systems and significantly lower than SPS systems. The typical RHP system size should be smaller than resistance heater systems and significantly smaller than SPS systems. The heating rates should be at least as fast as SPS systems (which are significantly faster than resistance heater systems). RHP offers significant design flexibility compared to conventional hot pressing systems. In addition, RHP processes are readily scalable (similar to resistance heater processes). Finally, the RHP process does not introduce any chemistry issues as the known SPS processes do.

An exemplary hot press system described herein can rapidly consolidate thermoelectric materials over a large temperature range (373-2273 K) within an inert atmosphere. The heat in this exemplary system can be provided by an induction coil operated in the radio frequency (RF) range applied directly to a graphite die which simultaneously operates as a susceptor. Utilizing a hydraulic control system to apply pressure, the consolidation of samples can be monitored to determine the minimum required pressing time. Fabrication and maintenance of suitable systems according to embodiments of the invention can cost significantly less than known commercial resistance heated or SPS hot presses. The described rapid hot pressing apparatuses and methods can provide an economic and robust systems for research, development, and production of materials for a variety of purposes as detailed hereafter.

The exemplary RHP system disclosed herein operates using induction heating and is at least as fast as SPS for the rapid consolidation of materials, but without the effects of a DC current. Such a system can be ideal for maintaining small and nanometer scale microstructures. The described techniques have been demonstrated by consolidating dense PbTe based thermoelectric materials at approximately 623 K for 5 minutes as well as SiGe based materials by heating to 1433 K at a rate of 600-800 K/min with similar thermoelectric properties as materials produced using conventional hot pressing for a much longer time.

Rapid consolidation of material over a wide temperature range under selectable atmospheres can be achieved using RHP techniques. Densification of samples can take place under uniaxial pressure in a graphite die acting as a susceptor within an RF induction coil. Thermoelectric material produced can be consolidated in such a system yielding a suitable Seebeck coefficient, resistivity, and thermal diffusivity. Thus, the technique is capable of producing functional material quickly at low and high temperatures.

With regard to the cost of the system fabrication and maintenance, embodiments of the present invention can provide a less expensive system as it may be constructed from readily available and affordable components. The overall footprint of a typical embodiment of the invention is made smaller due to the compact size of the induction power supply, which is drastically smaller than the power supply hardware required for either known resistance heater or SPS hot pressing systems.

### 2. Exemplary Rapid Hot Pressing System Using Inductive Heating

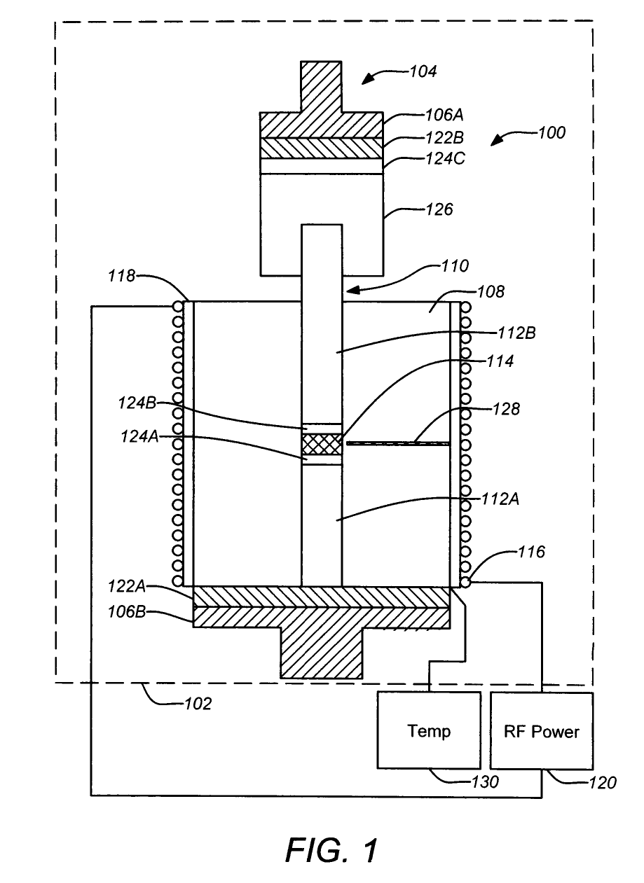

FIG. 1 is a schematic diagram of an exemplary rapid hot pressing (RHP) system 100 for rapid hot pressing according to an embodiment of the invention. A typical RHP system 100 may be enclosed in a vacuum chamber 102 (indicated by the dotted line) such that the pressure and/or gas environment may be altered depending upon the application. The RHP system 100 operates using a ram press 104 which includes a top pressing ram 106A and a bottom pressing ram 106B. In the RHP system 100, the bottom pressing ram 106B supports the graphite die 108 having a central bore therethrough. A stack 110 of elements is disposed through the central bore of the graphite die 108. The stack comprises a first graphite rod 112A, a powdered material 114 disposed above the first graphite rod 112A, and a second graphite rod 112B disposed above the powdered material 114 such that the second graphite rod 112B extends beyond a top surface of the graphite die 108. Note that the second graphite rod 112B must extend beyond the top surface of the graphite die 108 a sufficient distance to operate during hot pressing so that the press 104 does not contact the top surface of the graphite die 108. All graphite elements, e.g. the graphite die and the first and the second graphite rods, typically comprise high strength, high thermal conductivity graphite known in the art. A top ram cap 126 may be used to carry the second graphite rod 112B.

An inductive coil 116 is disposed around the graphite die 108. In addition, an insulator 118 is disposed between the graphite die 108 and the inductive coil 116 to prevent shorting of the inductive coil 116 against the graphite die 108. The insulator 118 may comprises quartz or other suitable ceramics known in the art. The inductive coil 116 comprises a conductive material, such as copper. The coil 116, insulator 118, and the graphite die 108 are all cylindrical. An additional important feature of the insulator 118 is that it serves to align the inductive coil 116 with the graphite die 108 in order to achieve optimum heating of the die 108. The inductive coil 116 is powered by an RF electrical power supply 120 such that heat is generated directly within the outer cylindrical region of the graphite die 108 as electrical currents are induced from the changing magnetic field driven by the applied RF electrical power supply 120. (In an example system 100, under typical conditions at the maximum heating rate (power), the heated region of the graphite die can been estimated to be approximately the outer 8 mm of a 76 mm diameter die. The heat generated in this region conducts to the center of the graphite die 108 and the powdered material 114. Thus, the graphite die 108 simultaneously functions as both the die and susceptor for the hot press. The graphite die 108 is heated by the inductive coil 116 and the powdered material 114 is then heated by the graphite die 108.

The ram press 104 is disposed to apply pressure to the stack 110 of elements. The graphite die 108 and the inductive coil 116 are disposed to remain fixed as the ram press 104 applies pressure to the stack 110 in order to consolidate the powdered material 114. This may be achieved through the use of a ceramic spacer 122A disposed to support both the graphite die 108 and the first graphite rod 112A; both are supported against a common surface. Use of a ceramic material for the spacer 122A aids thermal insulation. Accordingly, another ceramic spacer 122B may be disposed at the top of the stack 110 before the top pressing ram 106A. In order to obtain vertical alignment of the powdered material 114 within the graphite die 108 and the inductive coil 116 to optimize heating, the stack 110 may further comprise one or more graphite spacers 124A, 124B, 124C wherever suitable. In order to aid control of the RHP process, one or more thermocouples 128 may be disposed within the graphite die 108 and coupled to a monitor 130 in order to monitor the temperature of the graphite die 108.

Although the RHP process can consolidate powdered material as rapidly as SPS, in RHP only the die body is heated inside the induction coil, enabling faster cooling of the die and chamber. The more directed heating and faster cooling of REP compared to SPS can also enable higher peak temperature in an RHP as induction heating is known to achieve temperatures above 2773 K at the susceptor.

In a typical RHP system the induction coil can be easily produced from readily available inexpensive copper tubing and can be readily replaced or redesigned. Lastly, RHP can be easily scaled up for consolidation of large quantities of material for production purposes. Consolidation of larger amounts of material requires using larger diameter dies, chambers, power supplies, and possibly a larger induction coil. In a typical RIP system, various die sizes can be used with the same induction coil without additional changes to the system, however.

One specific example RHP system may be retrofitted onto an Instron 1350 mechanical testing load frame and hydraulic system allowing for precise control of the pressing ram position and applied load. A Centorr M60 Multi-Purpose vacuum chamber may be incorporated into the load frame with vacuum bellows attached to the pressing rams. The chamber walls and additional copper cooling plates may be cooled with a closed-loop water chiller that additionally serves to cool the diffusion pump, hydraulic system, induction coil, and induction power supply. The system can be operated under vacuum or backfilled with a desired gas. A typical vacuum level before inert gas backfilling of 3×10⁻⁵ Torr may be achieved in 1 hour, while the ultimate pressure of the system may be approximately 3×10⁻⁶ Torr. The chamber may use feedthroughs for up to four thermocouples, one of which can be used for control of the die temperature. The other thermocouples can be used to monitor the temperature of the chamber, steel pressing ram, and/or additional locations within the die.

The process control thermocouple may be located approximately 3 mm from the sample in the die and may be monitored using a programmable digital controller that supplies input to the induction power supply system creating a feedback loop that controls the temperature of the die. Although the thermocouple passes through the induction coil the accuracy of this thermocouple configuration can be verified by inserting an additional thermocouple in the top of the die extending to the sample location. The penetration depth, the thickness of the layer around the outside of the graphite die where the majority (87%) of the heat is developed by the current, may be approximately 8 mm.

As previously described, the graphite die acts as a susceptor as it converts the electromagnetic energy to heat and conducts the heat through the die to the sample. Such a system may be operated up to 1433 K, using 20 kW from the induction heater. Those skilled in the art will appreciated that higher temperatures are readily possible using the 25 kW power supply. An example graphite die that may be used in the system is approximately 76 mm in diameter with a 12 mm bore through the center of the die body and can be heated at a rate of approximately 600-800 K/min. Different sized die bodies can be readily used within the same induction coil and the bore diameter in the die can be varied to allow different sample diameters depending upon the desired application.

When loading the die for pressing, the first piece placed in the die is typically a graphite rod. The first graphite rod allows the sample being pressed to be located in the middle of the induction coil as well as in the same location as the process thermocouple for monitoring temperature accurately. The following elements may then be place in the die bore on top of the first graphite rod in order: a first graphite spacer, the sample, a second graphite spacer, and finally a second graphite rod. The graphite spacers are sized to isolate the longer rods from the sample as well as to adjust the height of the top rod in the die. After loading the sample into the die and placing the die in the induction coil the chamber door is closed and a vacuum is applied to the chamber. When an acceptable vacuum has been reached, the desired load is applied to the die, the chamber is backfilled with Ar (or other suitable inert gas) and flowed through the chamber, and the induction heating power supply is turned on to being the heating.

In addition to the temperature, the position of the pressing ram is monitored by recording the voltage applied to the hydraulic actuator controlling the hydraulic ram. Pressing takes place in a constant load condition and the pressing ram position is automatically varied to maintain the desired load. The maximum load for this demonstration was 510 kg. The maximum load is determined by the rod diameter and the strength of the graphite used. As the sample consolidates the ram will move upward to maintain the desired load and by monitoring the ram position the time at which consolidation of the sample is complete can be determined from the time after which the pressing ram stops moving. Determining the time at which the sample is fully consolidated allows for optimization of the pressing procedure by avoiding unnecessary time at elevated temperatures.

The initial characterization of the RHP technique was performed using a example PbTe powdered material developed as follows. Elemental Pb and Te (99.999+% purity) were sealed in a quartz vial under Ar atmosphere and held at 1248 K for two hours and subsequently quenched in water followed by heating to 873 K and holding for twenty-four hours. The resulting ingot of material was ball milled for eight hours to yield the powder. The powdered material with the composition PbTe:Na (2%) can then be consolidated using the induction hot press and the thermoelectric properties measured to confirm viability of the process.

Prior to sample consolidation an initial graphite run may be made in which the die arrangement to be used for pressing powder is placed in the hot press without powder included and heated to a pressing temperature of 623 K while the displacement of the pressing ram was recorded. The initial graphite run may be used to take account of the thermal expansion of the system and allows for full characterization of the pressing profile leading to more accurate determination of the minimum pressing time required to consolidate a specific sample. Powder of the material to be consolidated may the be loaded into the graphite die as described above and heated to 623 K and held for 10 minutes.

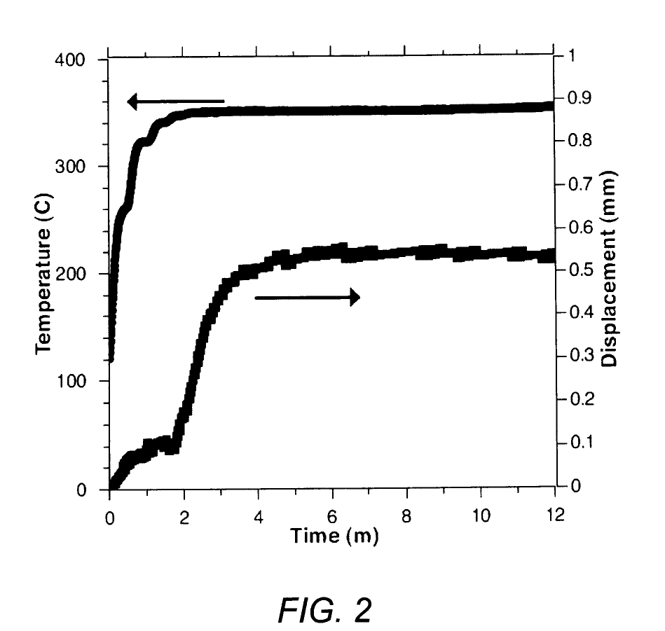

FIG. 2 is an example plot of temperature versus ram displacement for consolidation of a sample at 623 K for 10 minutes. The displacement data from the graphite run was subtracted from the displacement data from the sample run resulting in data representing only the displacement occurring due to the consolidation of the sample. The plot shows that the die reaches the pressing temperature after 2 minutes and that during heating the pressing ram is moving, indicating that consolidation is taking place. After a total time of approximately 7 minutes, 5 minutes at 623 K, the displacement has become stable indicating the minimum time required at this temperature to produce a dense sample. The sample pressed at 623 K for 10 minutes was 98% of the theoretical density. An additional sample of PbTe was pressed at 623 K for 5 minutes and was found to have a density of 98% of the theoretical density as well.

Using the results of the example PbTe consolidation runs as a guideline for a consolidation process, a sample of PbTe:Na (2%) was consolidated in the RHP at 623 K for 5 minutes. The density of the sample was 98% of the theoretical value. An additional PbTe:Na (2%) sample was pressed at typical consolidation parameters of 700 K for 60 minutes with density >98%. The Seebeck coefficient may be calculated from the slope of the thermopower versus temperature gradient measurements by Chromel-Nb thermocouples, while the resistivity was measured using the Van der Pauw technique under a reversible magnetic field of 2T, and the thermal diffusivity measurement was made by the laser flash method (Netzsch LFA 457).

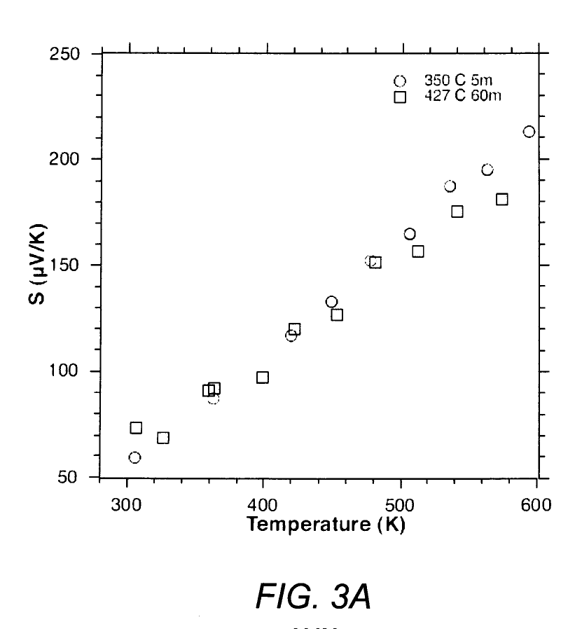

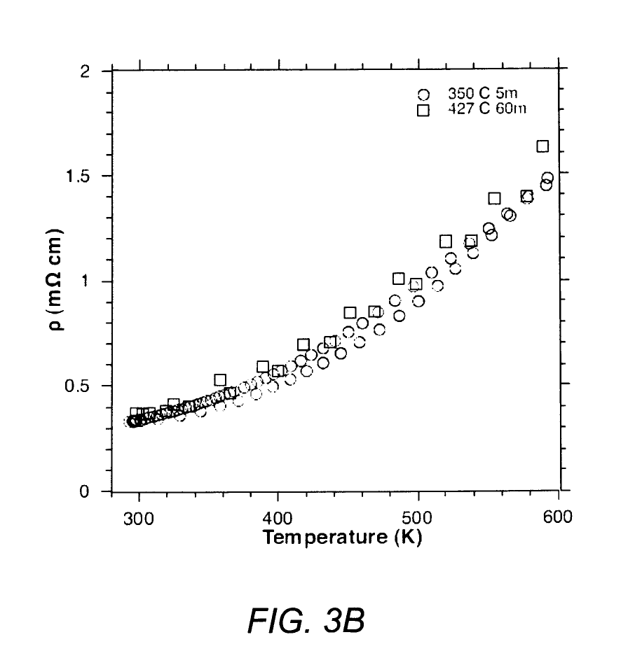

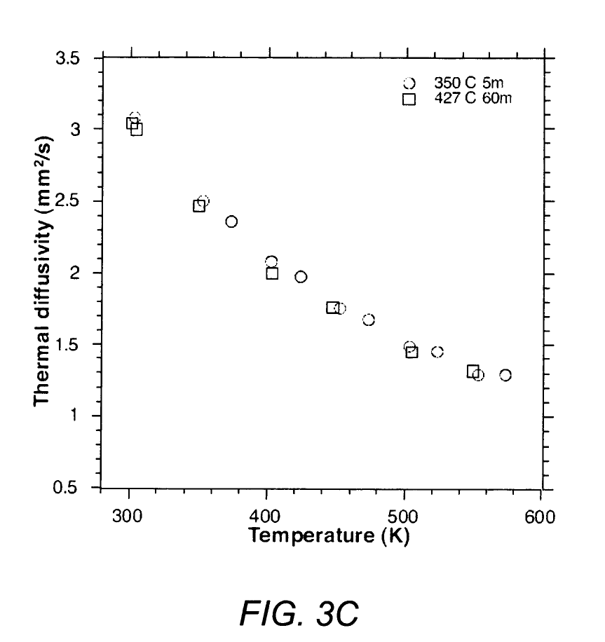

FIGS. 3A to 3C show heating and cooling data plots of the measured Seebeck coefficient, resistivity, and thermal diffusivity, respectively, for two example PbTe samples under vacuum. It is demonstrated from the agreement between the presented properties for these two samples that material of equivalent functionality can be produced using the RHP method under pressing conditions that minimize time and temperature required to produce dense thermoelectric material. It can also be noted that in another example the RHP process can be operated at 1433 K heating at a rate of 600-800 K/m to produced SiGe that was greater than 96% dense is less than 1 minute of pressing similar other known materials.

### 4. Exemplary Method of Rapid Hot Pressing Using Inductive Heating

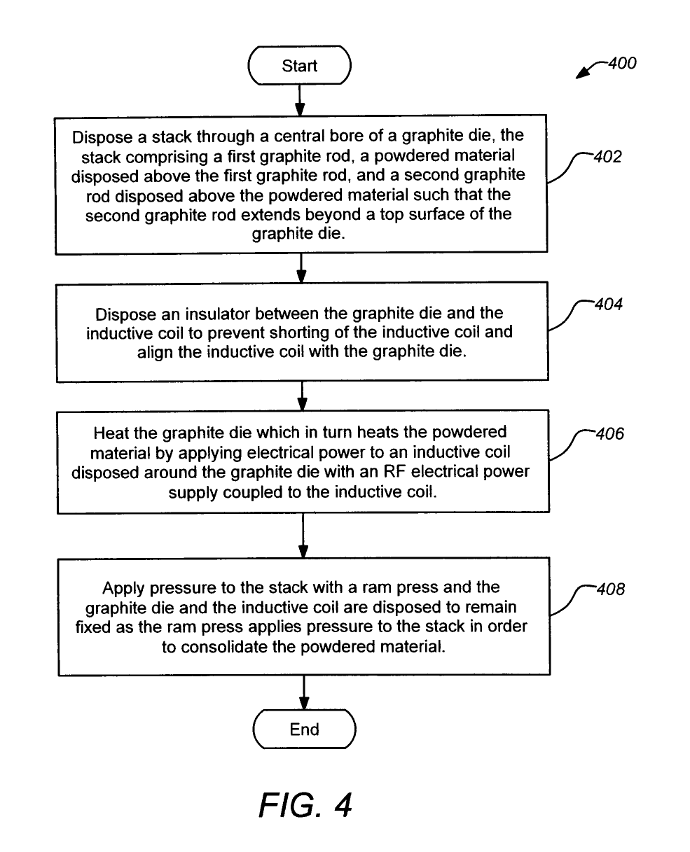

FIG. 4 is a flowchart of an exemplary method 400 of rapid hot pressing according to an embodiment of the invention. The method 400 begins with an operation 402 of disposing a stack through a central bore of a graphite die, the stack comprising a first graphite rod, a powdered material disposed above the first graphite rod, and a second graphite rod disposed above the powdered material such that the second graphite rod extends beyond a top surface of the graphite die. In operation 404, an insulator is disposed between the graphite die and the inductive coil to prevent shorting of the inductive coil and align the inductive coil with the graphite die. In operation 406, the graphite die is heated which in turn heats the powdered material by applying electrical power to an inductive coil disposed around the graphite die with an RF electrical power supply coupled to the inductive coil. In operation 408, pressure is applied to the stack with a ram press and the graphite die and the inductive coil are disposed to remain fixed as the ram press applies pressure to the stack in order to consolidate the powdered material. The method 400 may be further modified consistent with the apparatuses and material parameters previously described as will be understood by those skilled in the art.

Variations in the sequence of operations may be employed depending upon the particular application and powdered material. For example, in some cases the operation 406 of heating the graphite die may be performed prior to applying pressure to the stack in operation 408. Alternately, these operations 406, 408 may be performed simultaneously. However, typically some heating is initiated prior to applying pressure to the stack. Those skilled in the art can develop specific temperature and timing of pressure for particular powdered materials without undue experimentation.

This concludes the description including the preferred embodiments of the present invention. The foregoing description including the preferred embodiment of the invention has been presented for the purposes of illustration and description. It is not intended to be exhaustive or to limit the invention to the precise forms disclosed. Many modifications and variations are possible within the scope of the foregoing teachings. Additional variations of the present invention may be devised without departing from the inventive concept as set forth in the following claims.

What is claimed is:

1. An apparatus, comprising:
a graphite die having a central bore therethrough;
a stack disposed through the central bore comprising, a first graphite rod, a powdered material disposed above the first graphite rod, and a second graphite rod disposed above the powdered material such that the second graphite rod extends beyond a top surface of the graphite die;
a ram press disposed to apply pressure to the stack;
an inductive coil disposed around the graphite die;
an insulator disposed between the graphite die and the inductive coil to prevent shorting of the inductive coil and align the inductive coil with the graphite die; and
an RF electrical power supply coupled to the inductive coil for powering the conductive coil and heating the graphite die;
wherein the powdered material is heated by the graphite die and the graphite die and the inductive coil are disposed to remain fixed as the ram press applies pressure to the stack in order to consolidate the powdered material.

2. The apparatus of claim 1, further comprising one or more thermocouples disposed within the graphite die in order to monitor temperature of the graphite die.

3. The apparatus of claim 1, wherein the stack further comprises one or more graphite spacers in order to obtain vertical alignment of the powdered material within the graphite die and the inductive coil.

4. The apparatus of claim 1, wherein a ceramic spacer is disposed to support both the graphite die and the first graphite rod.

5. The apparatus of claim 1, wherein the graphite die and the first and the second graphite rods comprise high strength, high thermal conductivity graphite.

6. The apparatus of claim 1, wherein the powdered material comprises semiconductor material.

7. The apparatus of claim 6, wherein the semiconductor material comprises SiGe.

8. The apparatus of claim 6, wherein the semiconductor material comprises a thermoelectric material.

9. The apparatus of claim 8, wherein the thermoelectric material comprises PbTe.

10. A method of rapid hot pressing comprising the steps of:
disposing a stack through a central bore of a graphite die, the stack comprising a first graphite rod, a powdered material disposed above the first graphite rod, and a second graphite rod disposed above the powdered material such that the second graphite rod extends beyond a top surface of the graphite die;
disposing an insulator between the graphite die and the inductive coil to prevent shorting of the inductive coil and align the inductive coil with the graphite die;
heating the graphite die by applying electrical power to an inductive coil disposed around the graphite die with an RF electrical power supply coupled to the inductive coil for powering the conductive coil; and
applying pressure to the stack with a ram press;
wherein the powdered material is heated by the graphite die and the graphite die and the inductive coil are disposed to remain fixed as the ram press applies pressure to the stack in order to consolidate the powdered material.

11. The method of claim 10, further monitoring temperature of the graphite die with one or more thermocouples disposed within the graphite die.

12. The method of claim 10, further comprising disposing one or more graphite spacers within the stack in order to obtain vertical alignment of the powdered material within the graphite die and the inductive coil.

13. The method of claim 10, further comprising supporting both the graphite die and the first graphite rod with a ceramic spacer.

14. The method of claim 10, wherein the graphite die and the first and the second graphite rods comprise high strength, high thermal conductivity graphite.

15. The method of claim 10, wherein the powdered material comprises semiconductor material.

16. The method of claim 15, wherein the semiconductor material comprises SiGe.

17. The method of claim 15, wherein the semiconductor material comprises a thermoelectric material.

18. The method of claim 17, wherein the thermoelectric material comprises PbTe.

19. An apparatus, comprising:
a graphite die means for supporting and heating a powdered material having a central bore therethrough;
a stack disposed through the central bore comprising, a first graphite rod, the powdered material disposed above the first graphite rod, and a second graphite rod disposed above the powdered material such that the second graphite rod extends beyond a top surface of the graphite die means;
a ram press means for applying pressure to the stack;
an inductive coil means for heating the graphite die means disposed around the graphite die means;
an insulator means for insulating and aligning the inductive coil means and the graphite die means, the insulator means disposed between the graphite die means and the inductive coil means; and
an RF electrical power supply means for powering the conductive coil means and heating the graphite die means coupled to the inductive coil means;
wherein the powdered material is heated by the graphite die means and the graphite die means and the inductive coil means are disposed to remain fixed as the ram press means applies pressure to the stack in order to consolidate the powdered material.

20. The apparatus of claim 19, wherein the stack further comprises one or more graphite spacers in order to obtain vertical alignment of the powdered material within the graphite die means and the inductive coil means.
